(19) United States
(12) Patent Application Publication
(10) Pub. No.: US 2002/0142114 A1
(43) Pub. Date: Oct. 3, 2002

(54) Molded product for light-sensitive material, light-sensitive material package and production process therefor

(75) Inventors: Kazunori Mizuno, Kanagawa (JP); Osamu Suzuki, Kanagawa (JP); Taro Yamamoto, Kanagawa (JP)

Correspondence Address: SUGHRUE MION, PLLC, 2100 PENNSYLVANIA AVENUE, N.W., WASHINGTON, DC, 20037, US

(73) Assignee: FUJI PHOTO FILM CO., LTD.

(21) Appl. No.: 10/053,583

(22) Filed: Jan. 24, 2002

(30) Foreign Application Priority Data
Jan. 25, 2001 (JP) 2001-17106

(51) Int. Cl. B32B 1/00; B32B 1/08; B29C 43/10; B29C 49/00; G03C 1/00

(52) U.S. Cl. 428/34.3; 428/220; 264/570; 430/496

(57) ABSTRACT

A molded product for a light-sensitive material has a component ratio by weight of paper-derived cellulose fibers to the total of thermoplastic resins in the range of 51:49 to 75:25 and includes at least one antioxidant, and at least one aldehyde-neutralizing agent. A light-sensitive material package is formed from the molded product and a light-sensitive material that is used with the molded product. Furthermore, a process for producing the molded product includes mixing a thermoplastic resin having a melt flow rate of at least 15 g/10 min. with pellets formed by breaking, compressing and granulating a base paper produced for printing paper, so that the component proportions are 51 to 75 parts by weight of paper-derived cellulose fibers and 49 to 25 parts by weight of the total of the thermoplastic resins, and then molding the mixture at a cylinder temperature of 180° C. or less.

### BACKGROUND OF THE INVENTION

1. Field of the Invention

The present invention relates to a molded product for a light-sensitive material, the molded product being represented by, for example, a container for housing a light-sensitive material such as photographic film or printing paper, and including a member that is used for storing a roll of light-sensitive material, etc.; a light-sensitive material package that is formed from the molded product and a light-sensitive material that is used together with the molded product; and a production process therefor.

2. Description of the Related Art

In current molded products for light-sensitive materials, thermoplastic resins such as polystyrene (PS), polypropylene (PP), and polyethylene (PE) are widely used for their photographic properties, strength, etc. When such thermoplastic resins are used in molded products for light-sensitive materials, a large environmental burden is imposed when they are disposed of after use. Reducing this environmental burden is an urgent task. As one substitute, a paper/resin mixture (hereinafter, also called a ‘paper resin’) in which the proportion of paper in the mixture exceeds 50 wt % is attracting attention.

With regard to the paper resin, a paper resin employing recycled paper or waterproof paper for printing paper in which both surfaces of a base paper are laminated with a polyolefin resin, that is to say, ‘WP (waterproof) paper’, has been disclosed; for example, Japanese Registered Patent No. 3007880 discloses paper resin pellets obtained by breaking recycled paper from horse-racing tickets, magazines, etc. (or WP paper) into a flock state, then mixing it with a polyolefin elastomer and making it into paper pellets by rotary compression, then blending with a desired resin such as PP, and processing it in an extrusion molding machine. Furthermore, JP-A-11-99522 (JP-A denotes ‘Japanese unexamined patent application publication’) also discloses a process for obtaining paper resin pellets in a similar manner to the above. However, it has been found that when these paper resin pellets are applied to a molded product for a light-sensitive material, for example, a molded product for a roll of light-sensitive printing material (a flange, a core cap, a molded cushioning material, etc.) or a molded product for a light-sensitive material for a color copier, the photographic properties, in particular the sensitivity, are degraded.

### BRIEF SUMMARY OF THE INVENTION

The present invention has been carried out in view of the above-mentioned circumstances.

It is an object of the present invention to provide a molded product for a light-sensitive material that does not degrade the photographic properties, has good mechanical properties, and imposes less environmental burden. It is another object of the present invention to provide a light-sensitive material package comprising the molded product for a light-sensitive material and a light-sensitive material that is used together with the molded product. It is yet another object of the present invention to provided a process for producing the above-mentioned molded product for a light-sensitive material. The ‘mechanical properties’ referred to here include the rigidity that prevents the deformation of an opening due to high speed air transfer.

The above-mentioned objects of the present invention have been accomplished as follows.

One aspect of the present invention provides the following means to solve the problem.

A molded product for a light-sensitive material having a component ratio by weight of paper-derived cellulose fibers to the total of thermoplastic resins in the range of 51:49 to 75:25, comprising at least one antioxidant and at least one aldehyde-neutralizing agent.

Another aspect of the present invention provides the following means to solve the problem.

A light-sensitive material package comprising a molded product for a light-sensitive material, and a light-sensitive material that is used with the molded product, the molded product for a light-sensitive material having a component ratio by weight of paper-derived cellulose fibers to the total of thermoplastic resins in the range of 51:49 to 75:25 and comprising at least one antioxidant and at least one aldehyde-neutralizing agent.

Yet another aspect of the present invention provides the following means to solve the problem.

A process for producing a molded product for a light-sensitive material comprising, in the following order, steps of mixing a thermoplastic resin having a melt flow rate of at least 15 g/10 min. with pellets formed by breaking, compressing and granulating a base paper produced for printing paper, so that the component proportions are 51 to 75 parts by weight of paper-derived cellulose fibers and 49 to 25 parts by weight of the total of the thermoplastic resins, and molding the mixture with a molding machine at a cylinder temperature of 180° C. or less.

### BRIEF DESCRIPTION OF THE SEVERAL VIEWS OF THE DRAWINGS

FIG. 1 is an exploded perspective view of a molded product for a light-sensitive material, which is one embodiment of the present invention.

FIG. 2 is a conceptual view of one example of the molded product for a light-sensitive material of the present invention.

FIG. 2 (A) is an exploded perspective view of a package, and FIG. 2 (B) and FIG. 2 (C) are perspective views of a cushioning material from different directions.

FIG. 3 is a perspective view of a molded product for a light-sensitive material, which is one embodiment of the present invention, and which is a container wherein a body and a lid are integrally molded.

FIG. 4 is a cross section showing a stationary disc and a rotary disc of one example of a refiner that can be used in a fiberizing step of the process for producing a molded product for a light-sensitive material of the present invention.

FIG. 5 is a lateral cross section of the example of the refiner that can be used in a fiberizing step of the process for producing a molded product for a light-sensitive material of the present invention.

FIG. 6 shows one example of a breaking machine that is used in a rough breaking step of the process for producing a molded product for a light-sensitive material of the present invention.

FIG. 7 is a cross section at line I-I in FIG. 6. DETAILED DESCRIPTION OF THE INVENTION

The ‘total of the thermoplastic resins’ referred to in the present invention denotes the total of the polyolefin resin with which the waterproof paper for printing paper is laminated and all the thermoplastic resin that is added during a production process. In the case where a lining layer is provided, the ‘total of the thermoplastic resins’ includes a thermoplastic resin used for the lining layer.

Furthermore, the light-sensitive material package comprises a molded product for a light-sensitive material and a light-sensitive material that is used together with the molded product. In the case where the molded product for a light-sensitive material is a container, a light-sensitive material can be housed therein to give a light-sensitive material package.

The above-mentioned aspects of the invention have been accomplished as a result of an intensive investigation by the present inventors with the aim of minimizing the decomposition of cellulose by molding at as low a temperature as possible, searching for an additive for suppressing the decomposition of cellulose, and chemically neutralizing trace amounts of cellulose decomposition products.

The above-mentioned objects, other objects, features, and advantages of the invention will become clear from the following description.

Materials for the molded product for a light-sensitive material of the present invention and representative production steps therefor are explained in detail below.

With regard to the base paper that can be used in the molded product for a light-sensitive material and the light-sensitive material package of the present invention, plant cellulose fiber, which is generally sold as pulp, can be used. Examples of starting materials used for the pulp include softwoods such as pine, cedar, and Japanese cypress, hardwoods such as beech, oak, and eucalyptus, and non-wood fibers such as Edgeworthia chrysantha and bamboo.

In order to conserve forestry resources, much attention has been paid to the reuse of paper resources, and it is also possible to use plant cellulose fiber that has been regenerated as recycled pulp by steps such as fiberizing, coarse screening, aging, deinking, fine screening and bleaching using recovered paper collected from domestic, business, and public transport premises, including newspapers, weekly publications, magazines and advertising handouts, and refuse and broke from binding and printing factories.

In the present invention it is preferable to use, as base-paper-derived cellulose fiber, a base paper produced for printing paper and/or a waterproof paper for printing paper obtained by laminating the base paper with a polyolefin resin.

In the present invention, the ‘base paper produced for printing paper’ refers preferably to a base paper that can be broken into cellulose fibers having a weight-average fiber length in the range of 0.30 to 0.50 mm. With regard to such a base paper, a base paper made from kraft pulp, etc. can be cited, and it is often used for printing paper, but a base paper that is used for other purposes can also be included in the ‘base paper produced for printing paper’ of the present invention as long as the aforementioned requirement for fiber length is satisfied. The weight-average fiber length can be measured using an optical measurement device such as that described in the examples below. The weight-average fiber length changes little from the value measured immediately after breaking to that measured during the molded product production process.

The ‘base paper produced for printing paper’ used in the present invention is preferably formed using hardwood bleached kraft pulp whose cellulose fibers, before the base paper is broken, have a weight-average fiber length in the range of 0.4 to 0.7 mm. A waterproof paper for printing paper obtained using the above-mentioned base paper is broken using a refiner, a pin mill etc. and the cellulose fibers thus obtained particularly preferably have a weight-average fiber length in the range of 0.30 to 0.50 mm as described above. When the weight-average fiber length of the cellulose fibers before breaking exceeds 0.7 mm, the kneadability with a resin tends to be degraded, and the kneading tends to require a high temperature of at least 250° C. and a long duration. When the fiber length is less than 0.4 mm, although it becomes possible to knead at a comparatively low temperature less than approximately 220° C. for a short time, the precision and strength of the paper resin molded product so obtained tend to be degraded. Use of a base paper employing cellulose fibers having a weight-average fiber length in the range of 0.4 mm to 0.7 mm before breaking can give a paper resin molded product having high surface smoothness, high molding precision, and high molding strength.

The length of the cellulose fibers is preferably uniform. A uniform length for the cellulose fibers allows the kneading step and the molding step in the paper resin molded product production process to be carried out uniformly and robustly. Furthermore, the time required for these steps can be shortened, thereby preventing excessive thermal energy being applied and minimizing the adverse effects on the photographic properties from the paper resin molded product so obtained.

The ‘base paper produced for printing paper’ used in the present invention is preferably formed using a hardwood (laubholz) bleached kraft pulp (LBKP) as a starting material. A method for paper making using an LBKP is disclosed in JP-A-10-245791.

The pulp that forms the ‘base paper produced for printing paper’ used in the present invention preferably has (1) an average degree of polymerization of 800 or more, or gives (2) a pH on the base paper surface of 6.0 or more, or (3) an internal bond strength in the base paper of 10 to 20 N-cm, and it is particularly preferable for the above-mentioned requirements (1), (2) and (3) to be satisfied simultaneously.

Details of these characteristics are described in JP-A-3-149542 (Japanese Registered Patent No. 2671154).

With regard to an additive that can be used in the ‘base paper produced for printing paper’, it is preferable to use an additive that is prepared so that it does not adversely affect the photographic properties. That is to say, the additive that is used in the base paper is preferably an additive that does not adversely affect the raw stock storability of photographic light-sensitive materials, storage stability of developed prints, etc.

Such an additive includes a sizing agent (a rosin, a higher fatty acid salt, an alkylketene dimer, an alkenyl succinate, etc.), a paper strength increasing agent (polyacrylamide, etc.), a fixing agent (aluminum sulfate, etc.), a pH adjusting agent (sodium aluminate, sodium hydroxide, etc.), a filler (clay, talc, calcium carbonate, etc.), and other additives (a dye, a slime control agent, etc.).

A base paper formed by using an amphoteric polyacrylamide (JP-A-59-31949) as a paper strength increasing agent is preferably used in the present invention. A particularly useful paper strength increasing agent is an amphoteric polyacrylamide having an average molecular weight of 2,500,000 to 5,000,000, the average molecular weight being measured by gel permeation chromatography. The amphoteric polyacrylamide is an amphoteric copolymer obtained by copolymerizing an anionic monomer and a cationic monomer using as the main monomer acrylamide or methacrylamide (JP-A-6-167767). The base paper is preferably a neutral paper that has been made in a neutral region in which the pH of the paper stock is in the range of 6.0 to 7.5. When the pH exceeds the above-mentioned range, the cellulose tends to be easily hydrolyzed. When the cellulose forming the base paper undergoes hydrolysis, its molecular weight (degree of polymerization) decreases, thereby degrading the strength of the base paper. The use of a base paper with a decreased molecular weight in the manufacture of paper resin pellets causes the problems that (1) the cellulose fibers easily undergo thermal decomposition during molding; (2) the Izod impact strength is degraded; (3) an acidic gas, etc. that adversely affects photographic properties is easily generated; and so on. It is therefore preferable for the base paper to be made in the neutral region so that the paper surface has a pH of 6.0 to 7.5.

With regard to a polyolefin that is used for producing waterproof paper for printing paper in which a polyolefin resin is laminated on both sides of the above-mentioned base paper, a homopolymer of an α-olefin such as polyethylene and a copolymer of α-olefins are preferred. Examples thereof include high-density polyethylene (HDPE), low-density polyethylene (LDPE), and a mixture thereof.

The molecular weight of these polyolefins is not particularly limited as long as a white pigment or a fluorescent whitener can be included in the laminated layer formed by extrusion coating, but a polyolefin having a molecular weight in the range of 20,000 to 200,000 is usually used.

The thickness of the polyolefin resin laminated layer is preferably 15 to 50 μm.

When the α-olefin homopolymer contains an additive, the additive is preferably one that does not adversely affect the raw stock storability of light-sensitive materials, the storage stability of developed prints, etc. It is particularly preferable to include a white pigment, a colored pigment, and an antioxidant in the polyolefin resin laminated layer on the side on which a photographic emulsion would be coated.

A typical layer structure of the waterproof paper for printing paper has, going from the front side on which the photographic emulsion would be coated to the opposite side; an LDPE layer containing titanium dioxide and zinc stearate, a base paper layer, and a mixed LDPE and HDPE layer containing calcium stearate. Typical basis weights are 21 to 32 g/m² for the first LDPE layer, 135 to 167 g/m² for the base paper layer, and 23 to 24 g/m² for the second, mixed LDPE/HDPE layer.

The production of a paper resin in the present invention can employ a base paper produced for printing paper but preferably employs a waterproof paper for printing paper in which the above-mentioned base paper is laminated with a polyolefin resin.

With regard to an additional thermoplastic resin that can be used in the present invention, there can be cited as preferable examples thereof polyolefins such as polyethylene (PE) and polypropylene (PP); polyesters such as polyethylene terephthalate and polybutylene terephthalate; polyamides such as nylon-6, nylon-6,6, nylon-11 and nylon-12; polystyrene; polystyrene copolymers, etc. In particular, a poly-α-olefin such as PE or PP, which has compatibility with a polyolefin resin that has been laminated on the base paper, is preferably used as the additional thermoplastic resin. The ‘additional thermoplastic resin’ referred to here denotes a separate thermoplastic resin from the polyolefin resin that has been laminated on the base paper, and does not exclude a thermoplastic resin having the same composition as that of the polyolefin resin used for the base paper lamination.

Use of an elastomer resin as a component of the thermoplastic resin can give an elastic molded product.

In the molded product and the package of the present invention, the mixing ratio by weight of the paper-derived cellulose fibers to the total of the thermoplastic resins is 51:49 to 75:25, and preferably 60:40 to 70:30.

When mixing an additional thermoplastic resin with a waterproof paper for printing paper in which 75 parts by weight of the base paper is laminated with 25 parts by weight of a polyolefin resin, in order to ensure that 51 wt % to 75 wt % of the molded product is formed from the base-paper-derived cellulose component, 47 to 0 parts by weight of the additional thermoplastic resin is added to 100 parts by weight of the waterproof paper for printing paper.

The antioxidant that can be preferably used in the present invention is a hindered phenol antioxidant, and its melting point is preferably at least 100° C., and particularly preferably at least 120° C.

Representative examples of the hindered phenols that can be used in the present invention are listed below.

1) 1,3,5-Trimethyl-2,4,6-tris(3,5-di-tert-butyl-4-hydroxybenzyl)benzene,

2) tetrakis[methylene-3-(3′,5′-di-tert-butyl-4′-hydroxyphenyl)propionate]methane,

3) octadecyl-3,5-di-tert-butyl-4-hydroxyhydrocinnamate,

4) 2,2′,2′-tris[(3,5-di-tert-butyl-4-hydroxyphenyl)propionyloxy]ethylisocyanurate,

5) 1,3,5-tris(4-tert-butyl-3-hydroxy-2,6-dimethylbenzyl)isocyanurate,

6) tetrakis(2,4-di-tert-butylphenyl) 4,4′-biphenylenediphosphite ester,

7) 4,4′-thiobis(6-tert-butyl-o-cresol),

8) tris(2-methyl-4-hydroxy-5-tert-butylphenyl)butane,

9) 2,2′-methylenebis(4-methyl-6-tert-butylphenol),

10) 4,4′-methylenebis(2,6-di-tert-butylphenol),

11) 4,4′-butylidenebis(3-methyl-6-tert-butylphenol),

12) 2,6-di-tert-butyl-4-methylphenol,

13) 4-hydroxymethyl-2,6-di-tert-butylphenol,

14) 2,6-di-tert-butyl-4-n-butylphenol,

15) 2,6-bis(2′-hydroxy-3′-tert-butyl-5′-methylbenzyl)-4-methylphenol,

16) 4,4′-methylenebis(6-tert-butyl-o-cresol),

17) 4,4′-butylidenebis(6-tert-butyl-m-cresol),

18) 3,9-bis{1,1-dimethyl-2-[β-(3-t-butyl-4-hydroxy-5-methylphenyl)propionyloxy]ethyl}-2,4,8,10-tetraoxaspiro[5,5]undecane,

19) 1,1,3-tris(2-methyl-4-hydroxy-5-t-butylphenyl)butane,

The amount of hindered phenol antioxidant added is 0.001 to 1.0 wt % of the total of the paper and the thermoplastic resins, preferably 0.005 to 0.8 wt %, more preferably 0.01 to 0.6 wt %, and most preferably 0.02 to 0.4 wt %.

It is preferable to add thermoplastic resin pellets containing an antioxidant in a concentrated form by melt-kneading, and the pellets are added to a mixture of the paper and the thermoplastic resins before molding at the latest. To elaborate, a desired amount thereof is added as concentrated pellets to a material supply tank immediately before molding. Preferably, paper resin pellets, which will be described below, and concentrated antioxidant pellets are metered individually and supplied to a hopper installed in a molding machine, and the mixture is kneaded and then molded.

The aldehyde-neutralizing agent used in the present invention is represented by general formula (I) below.

General Formula (I)

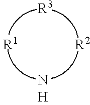

In the formula, R¹, R², and R³ denote divalent organic radicals and together form a cyclic imino compound via covalent bonds therebetween.

It is surmised that, due to the high reactivity of the imino group, the active imino compound represented by general formula (I) reacts, as shown in reaction formula (II) below, with an aldehyde such as furfural that is generated as a result of the thermal decomposition of cellulose in the paper resin, to form a methylol group.

R—NH—R′+HCHO→R(CH₂OH)—R′ (II)

In order for the imino group to have such a reactivity, it is essential for it to have a sufficiently low electron density and be able to induce an electronic nucleophilic reaction. It is therefore necessary for the organic radicals that are directly chemically bonded to the imino group to be electrophilic. Such organic radicals bonded to the imino group, that is to say, organic radicals denoted by R¹ and R² in the above-mentioned general formula (I), are preferably —CO—, —COO—, —NH—, —NH₂, a phenyl group, a biphenyl group, or a naphthalene group.

The aldehyde-neutralizing agent of the present invention is preferably neither released from the molded product after the molten mixing with the paper resin nor the cause of thermal decomposition. Preferable examples of the compound represented by general formula (I) include hydantoins and imidazoles, and hydantoins are preferred in the present invention.

As examples of the hydantoins, hydantoin, 5-isopropylhydantoin, 5,5-dimethylhydantoin, 5,5-diphenylhydantoin and allantoin can be cited, but they are not limited thereto.

With regard to the antioxidant and the aldehyde-neutralizing agent that can be used in the present invention, compounds that are generally known as an ‘antioxidant’ or an ‘aldehyde-neutralizing agent’ can be cited. Such antioxidants and neutralizing agents are described in, for example, Zenjiro Osawa ed. ‘Degradation and Stabilization of Macromolecular Materials (Kobunshizairyo no Rekka to Anteika)’ (May 1990, Published by CMC), Motonobu Minagawa ed. ‘Plastic Additive Usage Notes (Plastic Tenkazai Katsuyo Note)’ Jul. 5, 1996, Published by Kogyo Chosa Kai.

A cyclic organic compound having an active imino group represented by general formula (I) is added at 0.05 to 3.0 % wt of the total of the paper and the thermoplastic resins, preferably 0.06 to 2.0 wt %, and particularly preferably 0.067 to 1.0 wt %.

The method and the timing of the addition are the same as those in the case of the above-mentioned hindered phenol antioxidant.

It is preferable to add an antioxidant and an aldehyde-neutralizing agent in combination to the molded product of the present invention. The amounts thereof added are the same as in the case where they are used singly. The antioxidant of the present invention is added at at least 0.05 wt % and, in addition, when 5,5-dimethylhydantoin is used as the aldehyde-neutralizing agent, it is preferably added at at least 0.05 wt %.

The thickness of the molded product of the present invention is from 0.5 mm to 10 mm, preferably from 0.5 mm to 5 mm, and more preferably from 0.8 mm to 3 mm.

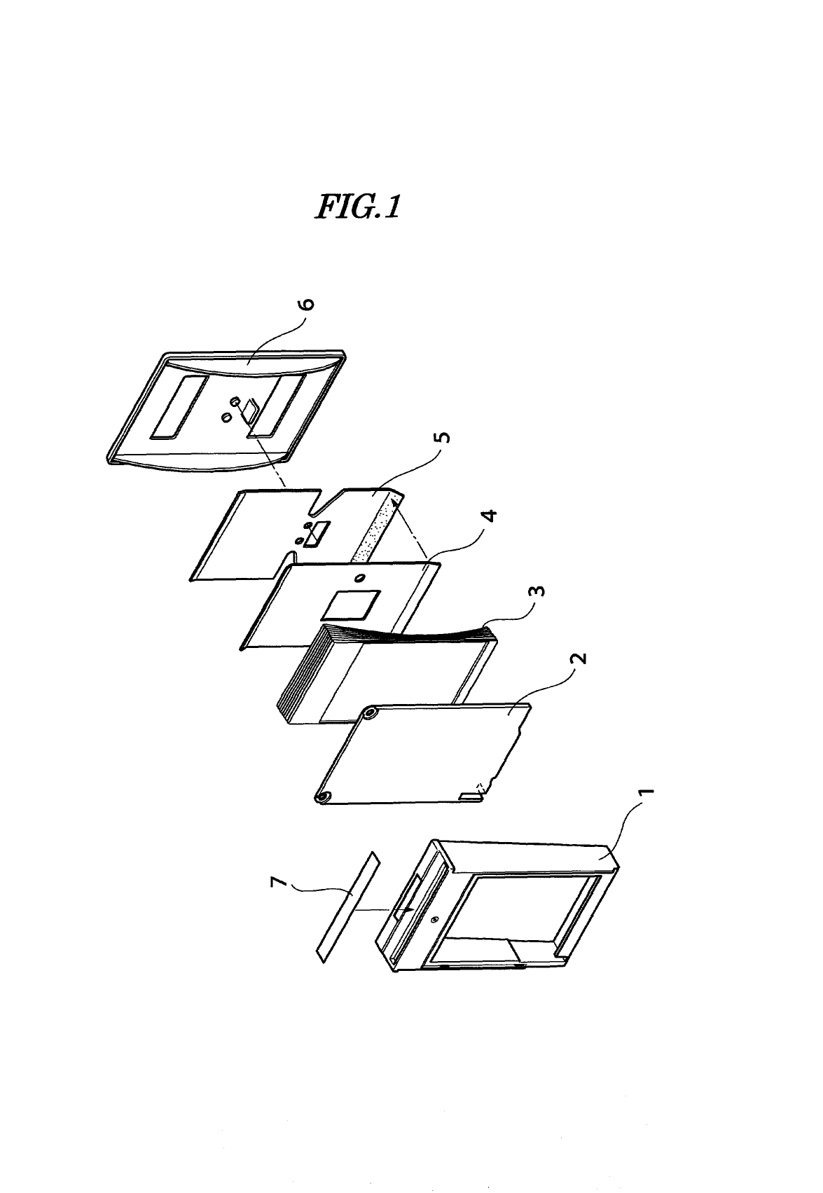

FIGS. 1 to 3 show embodiments of the molded product for a light-sensitive material in accordance with the present invention.

FIG. 1 shows an instant film pack, which is one embodiment of the present invention. The instant film pack includes a case main body 1, a film cover 2, a light-shielding sheet 4, a light-shielding sheet 5, a base plate 6, and a flap 7. The above-mentioned components 1 to 6 employ molded resin products, and the molded products of the present invention can be used for a part or the whole of these components. The components, together with a film 3, can be made into a light-sensitive material package.

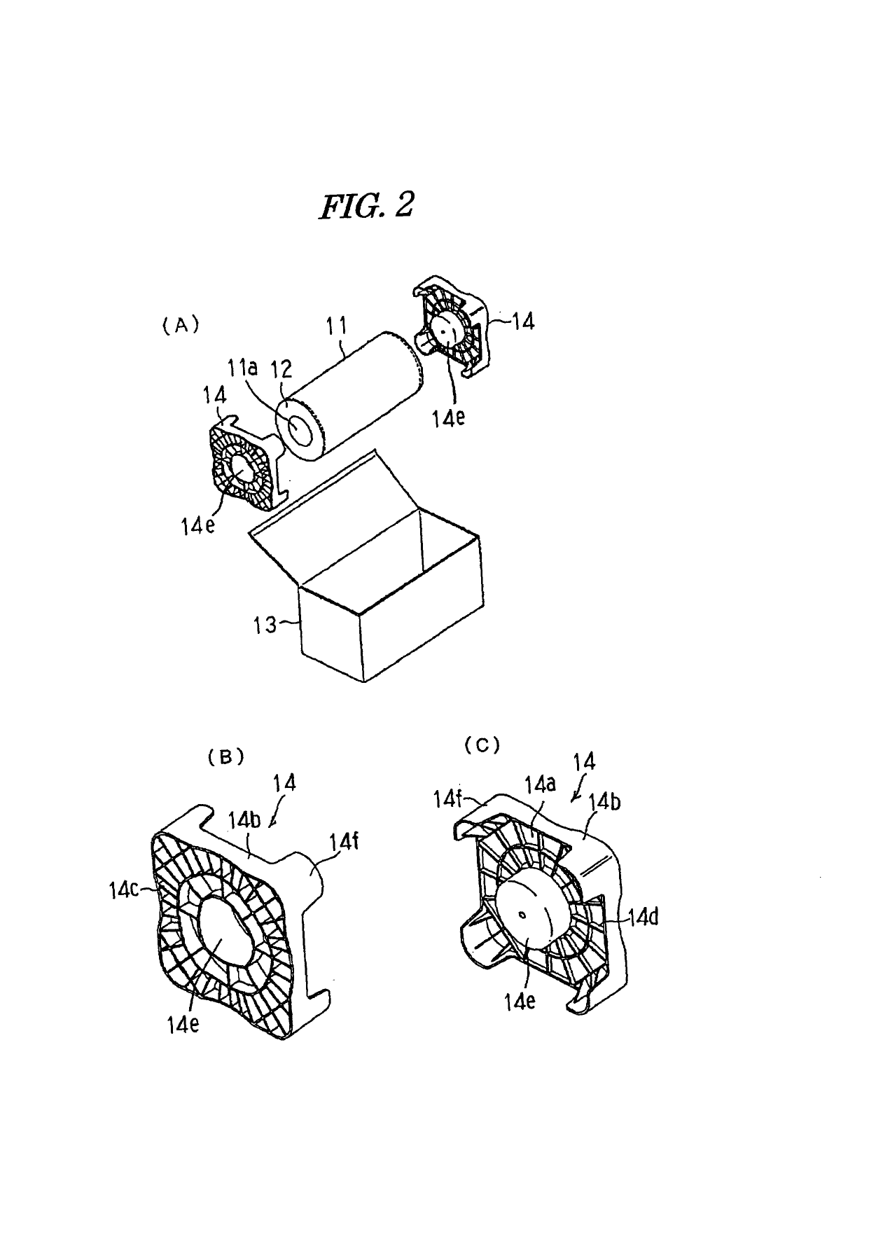

FIG. 2 shows cushioning materials and a package, which are embodiments of the present invention, that are used to store a long roll of light-sensitive material disclosed in JP-A-11-327089. FIG. 2 (A) is an exploded perspective view of the package, and FIG. 2 (B) and FIG. 2 (C) are perspective views of the cushioning material from different directions. The cushioning material 14 has a thickness of 1.5 mm, and is a molded product of the present invention.

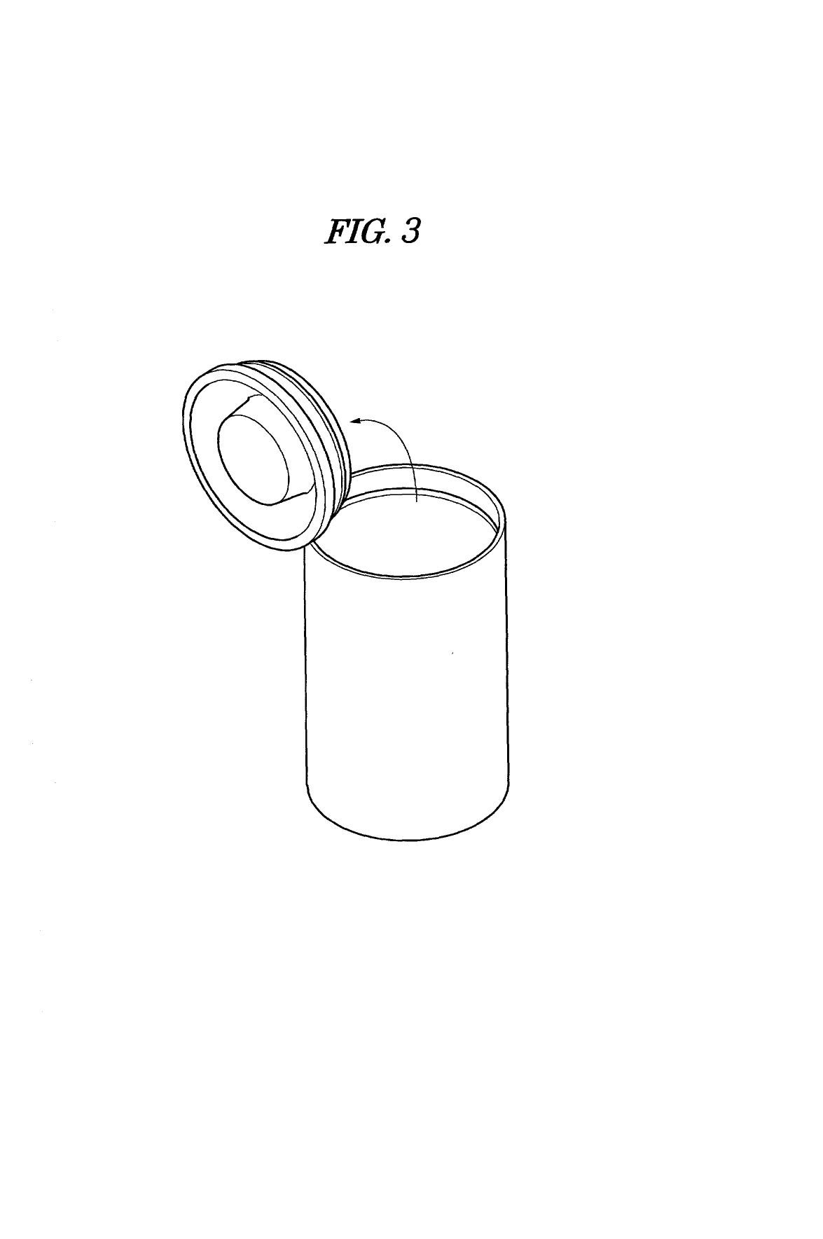

FIG. 3 is a perspective view showing a case main body and a lid for FUJICOLOR SUPERIA (registered trademark of Fuji Photo Film Co., Ltd.) 400, which is one embodiment of the present invention.

In FIG. 2, the outermost periphery of a roll of light-sensitive material 11 is covered with a light-shielding sheet so that the light-sensitive material is neither exposed to light nor damaged. A light-shielding protecting plate 12 is fixed to a paper tube 11a at each of the two ends of the roll of light-sensitive material 11 in its width direction so that the ends are neither exposed to light nor damaged. When inserting the roll of light-sensitive material 11 into a housing container 13, it is necessary to take care that the roll of light-sensitive material is not deformed or broken due to a physical shock such as a fall and that the roll of light-sensitive material is not exposed to light as a result of breakage of the light-shielding sheet or the protecting plate 12. The roll of light-sensitive material 11 is therefore inserted into the housing container 13 while supporting opposite ends of the paper tube 11a of the roll of light-sensitive material 11 by means of a pair of cushioning materials 14.

The cushioning material 14 is formed from a square substrate 14a made of a synthetic resin, a side wall 14b formed integrally on the outer periphery of the substrate 14a, a large number of reinforcing ribs 14c and 14d formed on both sides of the substrate 14a in radial directions and in directions that are orthogonal thereto, a cylindrical part 14e formed integrally on the central area of the substrate 14a and having its forward end closed, and projections 14f provided on the four corners of the substrate 14a so as to extend orthogonally therefrom. Inserting the cylindrical part 14e of the cushioning material 14 into the paper tube 11a supports the roll of light-sensitive material 11.

The molded product for a light-sensitive material of the present invention can be produced by various methods. The molded product for a light-sensitive material of the present invention is characterized in that a thermoplastic resin and a waterproof paper for printing paper, in which a base paper preferably produced for printing paper is laminated with a polyolefin, are used as starting materials, and it is molded so that the component ratio by weight of the base-paper-derived cellulose fibers and the total of the thermoplastic resins is in the range of 51:49 to 75:25 in the molded product for a light-sensitive material that is finally obtained. The ‘total of the thermoplastic resins’ referred to here denotes the total of the polyolefin resin that is laminated on the waterproof paper for printing paper and all of the thermoplastic resins that are added during the production process. Setting the lower limit of the proportion of the cellulose fiber component at 51 wt % ensures that the cellulose fibers are present at more than 50 wt % of the whole product.

With regard to the timing of the first addition of a thermoplastic resin, a choice can be made as to whether or not a mixture of cellulose fibers and a polyolefin resin, obtained by breaking the waterproof paper for printing paper, is by itself temporarily made into pellets. An example of the process for producing a molded product without forming the above-mentioned pellets is illustrated below:

1) A step in which a waterproof paper for printing paper, in which a base paper produced for printing paper is laminated with a polyolefin resin, is broken to give a mixture of cellulose fibers and the polyolefin resin; 2) a step in which an additional thermoplastic resin, which may be molten, is added if necessary to the mixture obtained above; and 3) a step in which a molded product for a light-sensitive material containing the base paper and the polyolefin resin is molded so that the component ratio by weight of the base-paper-derived cellulose fibers to the total of the thermoplastic resins is in the range of 51:49 to 75:25.

An example of the process for producing a molded product involving making a mixture of cellulose fibers and a polyolefin resin, which is obtained by breaking the waterproof paper for printing paper, into pellets is illustrated below:

1) A step in which a waterproof paper for printing paper, in which a base paper produced for printing paper is laminated with a polyolefin resin, is broken to give a mixture of cellulose fibers and the polyolefin resin; 2) a step in which the mixture so obtained is by itself temporarily made into pellets, the pellets so obtained are re-broken, and the broken cellulose fibers and polyolefin resin are kneaded with an additional thermoplastic resin at the same time as the re-breaking or separately; and 3) a step in which a molded product for a light-sensitive material containing the base paper and the polyolefin resin is molded so that the component ratio by weight of the base-paper-derived cellulose fibers to the total of the polyolefin resin and the additional thermoplastic resin is in the range of 51:49 to 75:25. This process is preferable since the compatibility of the cellulose fibers with the additional thermoplastic resin can be improved.

The above-mentioned steps can be carried out in a continuous sequence or the mixture, etc. obtained in each of the steps can be stored temporarily. The antioxidant and the aldehyde-neutralizing agent of the present invention are preferably added in the above-mentioned step 3).

A more detailed example of the process for producing a molded product for a light-sensitive material of the present invention is as follows.

Hereinafter, this production process example is called the ‘detailed production process example’. In the examples explained below, this ‘detailed production process example’ will be referred to.

(1) A waterproof paper for printing paper, in which a base paper produced for printing paper is laminated with a polyolefin resin, is roughly broken using a shearing machine. As one embodiment, it is cut into 30×30 mm square pieces.

(2) The waterproof paper roughly broken in this way is fiberized into cellulose fibers in a torn flock form by the beating action of pins using a pin mill or a breaking action under friction using a refiner.

(3) The bulky flock-form mixture of the cellulose fibers and the polyolefin resin is compression-kneaded using a pellet mill to give compact pellets.

(4) The pellets obtained in the above-mentioned step are subsequently broken using a turbo mill.

(5) An additional thermoplastic resin powder is added to the mixture of cellulose fibers and polyolefin resin so broken, and they are again kneaded to form pellets using a pellet mill.

(6) The pellets containing the cellulose fibers, the polyolefin resin, and the additional thermoplastic resin obtained in the above-mentioned step are kneaded using an extruder to give paper resin pellets.

(7) The paper resin pellets thus obtained, concentrated antioxidant pellets, and concentrated aldehyde-neutralizing pellets are supplied to an injection-molding machine and injection-molded into the desired form.

The above-mentioned steps can be modified in a variety of ways. For example, in the above-mentioned breaking step (4) the pellets obtained in step (3) and lumps of an additional thermoplastic resin may be broken together to give a mixture. This mixture can be supplied to the pellet mill in step (5).

It is surmised that, since the molded product for a light-sensitive material of the present invention uses a waterproof paper for printing paper as a starting material, the broken polyolefin resin and the broken cellulose fibers are uniformly mixed in step (2), which employs a pin mill or a refiner. It is therefore possible to achieve good mixing of the cellulose fibers, the polyolefin resin, and an additional thermoplastic resin with each other during the subsequent steps (3) to (5).

It is also possible to prepare the pellets in step (6) using an amount of thermoplastic resin that is smaller than the final amount that is to be added, and the remainder of the thermoplastic resin is added in order to mold a lining layer, etc. when injection-molding the molten pellets. The number of steps in which the thermoplastic resin is added and the amount thereof added can be chosen freely as long as the injection molding is carried out so that the component ratio by weight of the base paper to the total of the thermoplastic resins in the molded product is in the range of 51:49 to 75:25. The remainder of the thermoplastic resin can also be used for molding a lining layer by two-color molding or insert molding.

When the proportion of the base paper component exceeds 75 wt %, the injection pressure rapidly increases, thereby making it impossible to carry out injection molding in a stable manner. This upper limit is much higher in the case where a waterproof paper for printing paper is used than is the case where cellulose fibers from recycled newspaper, etc. are used by themselves as a starting material.

In the kneading operation in step (5) of the above-mentioned detailed production process example, the moisture content of the cellulose fibers that are kneaded with the thermoplastic resin is preferably 5 wt % to 40 wt %, and more preferably 10 wt % to 20 wt %. Maintaining this moisture content can fully utilize the resin-reinforcing function of the cellulose fibers.

A refiner that can be used in the fiberizing step (2) of the above-mentioned detailed production process example is explained below.

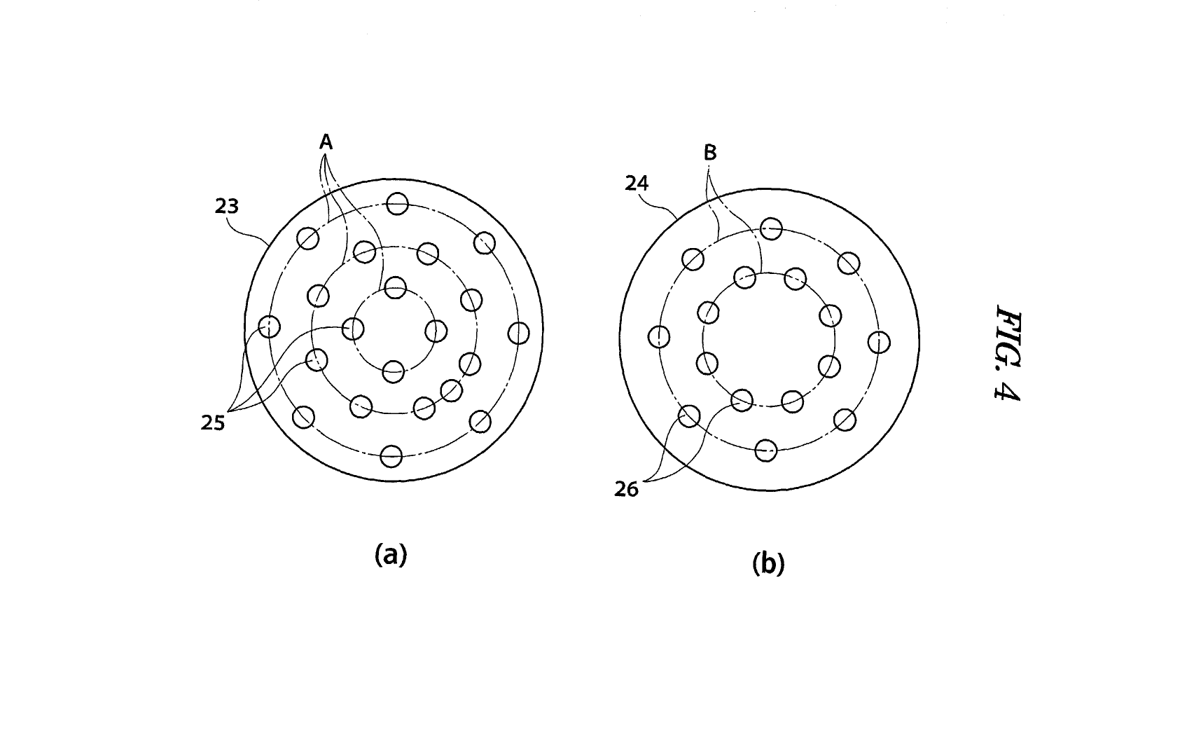

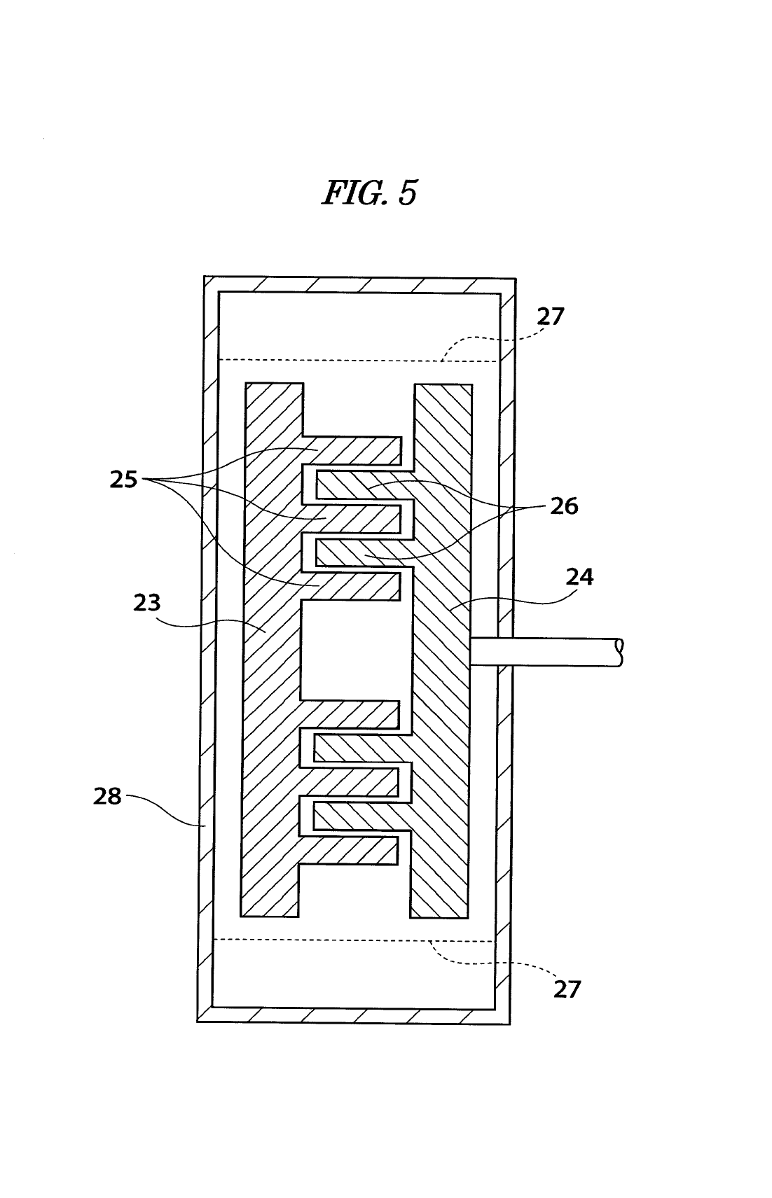

FIG. 4 shows cross sections of a stationary disc and a rotary disc of one example of the refiner. FIG. 5 is a lateral cross section of one example of the refiner.

This step is a step for fiberizing the cellulose fibers of the paper to break them into the flock-form cellulose fibers.

The refiner comprises a stationary disc 23 and a rotary disc 24. As shown in FIG. 4, the stationary disc 23 has stationary projections 25 arranged in a line on coaxial circles A on one side of the disc and the rotary disc 24 has moving projections 26 arranged on coaxial circles B on one side of the disc, the coaxial circles B being positioned between the coaxial circles A. As shown in FIG. 5, the above-mentioned stationary disc 23 and rotary disc 24 are made to face each other so that the stationary projections 25 and the moving projections 26 mesh with each other.

In this state, rotating the rotary disc 24 around its central axis abrades WP paper (or recycled paper), etc. between the stationary projections 25 and the moving projections 26, thereby breaking the paper.

In FIG. 5, 28 denotes a case and 27 denotes a mesh drum. Since the WP paper (or recycled paper) is broken by abrading it between the stationary projections 25 and the moving projections 26, the WP paper (or recycled paper) is kneaded and disentangled between the stationary projections 25 and the moving projections 26, thereby achieving sufficient fiberization while suppressing cutting of the fiber.

A turbo mill that can be used in step (4) of the detailed production process example is explained below.

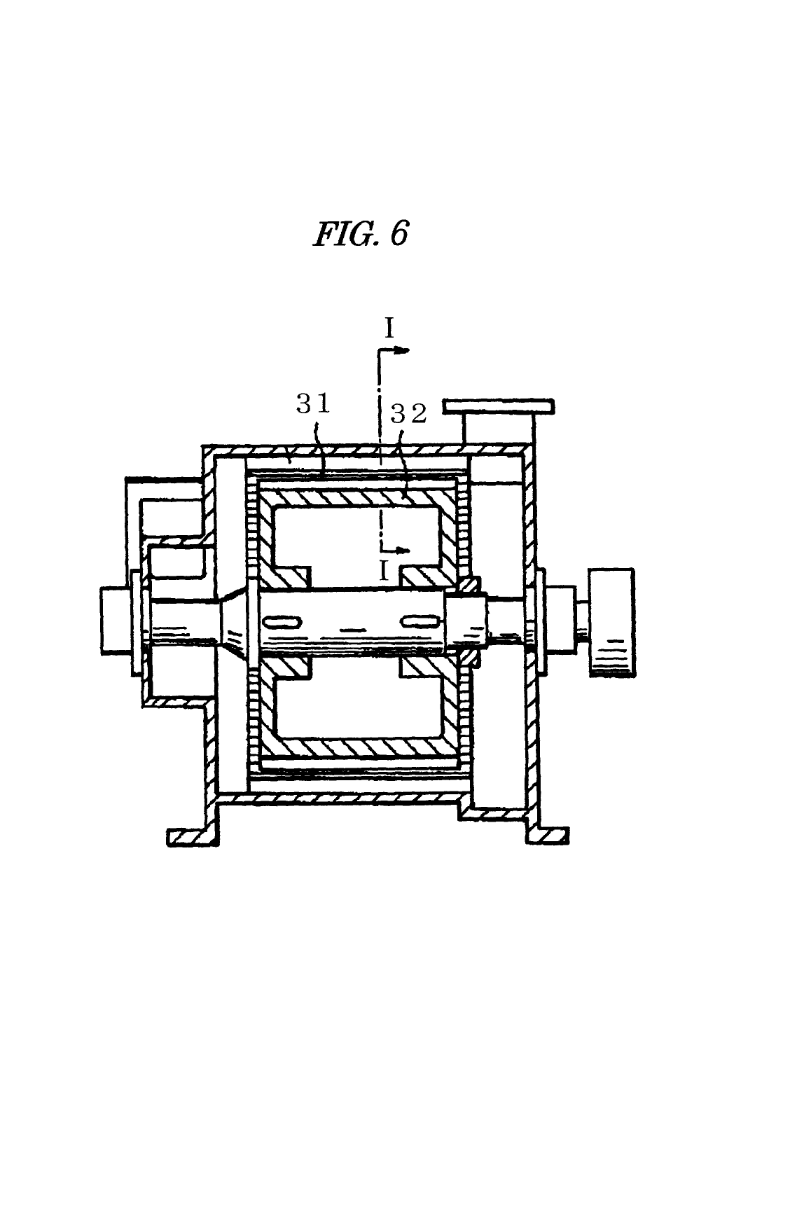

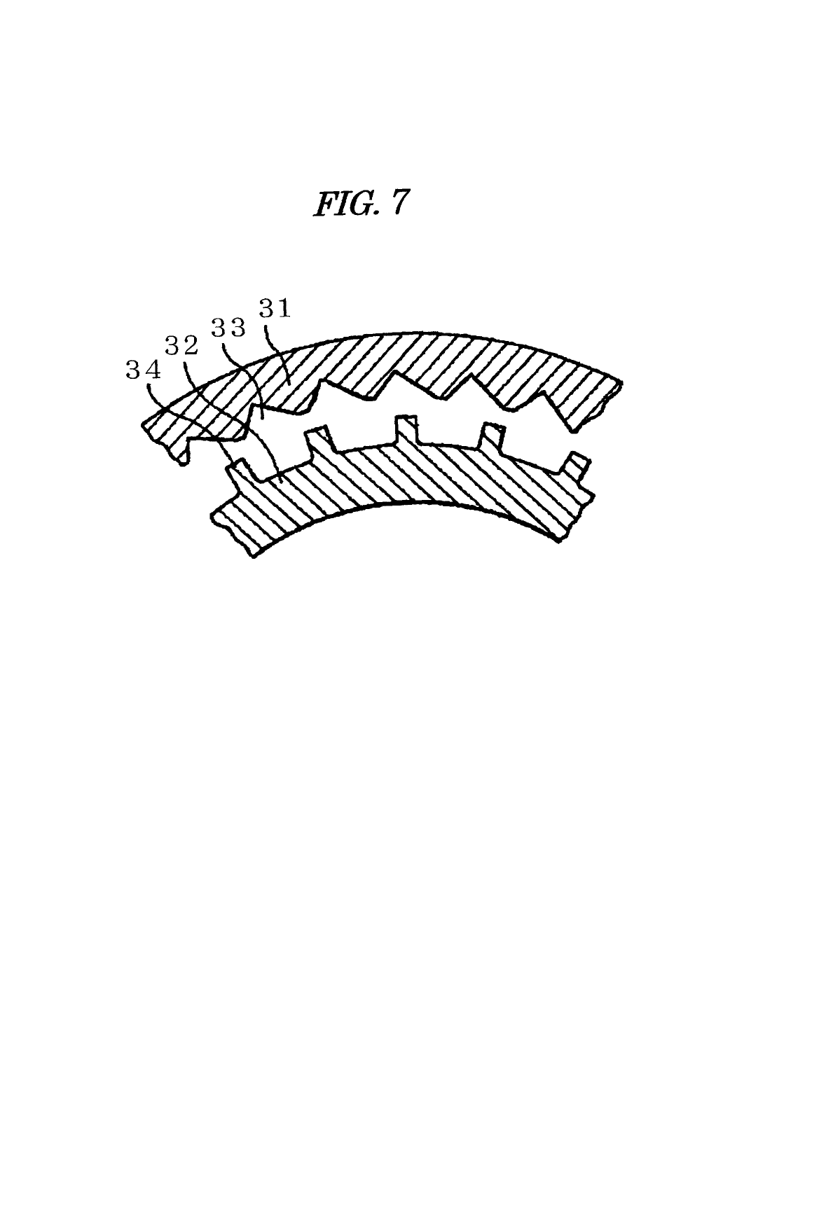

FIG. 6 is a vertical longitudinal cross section of a turbo mill. FIG. 7 is a magnified cross section at line I-I in FIG. 6, which shows the shape of a blade 31 having a triangular cross section and a rotor 32.

1) In the turbo mill as shown in FIG. 7, the inner face of the cylindrical blade 31 is provided with a large number of grooves 33 having a triangular cross section, and the cylindrical surface of the rotor 32 is provided with ridges 34.

2) The large number of ridges 34 of the rotor 32 rotating at high speed cause a flow of air around the outer circumference of the rotor 32, the air flow having a high flow rate in the rotational direction of the rotor 32. This air flow is compressed when the tips of the ridges 34 of the rotor 32 approach the grooves 33 provided on the inside of the blade 31, and the air flow is expanded when the tips of the ridges 34 depart from the grooves 33, thereby causing high frequency pressure vibrations.

3) In FIG. 6, pellets that are supplied through an inlet (not illustrated) are broken finely by the above-mentioned pressure vibrations.

4) The pellets that have been finely broken by the turbo mill are collected together with the air by a cyclone bag filter.

5) Controlling the number of turbo mill treatments can achieve a desired fiber length.

A known kneading machine such as a pressure type kneader can be used for kneading.

Other preferable conditions for the kneading step are described in JP-A-5-50427.

The kneading temperature is preferably from 90° C. to 220° C., and particularly preferably from 140° C. to 170° C. When the kneading temperature is less than 90° C., the kneading tends to be insufficient. This tendency can be observed to some extent until the temperature reaches 140° C. When the kneading temperature exceeds 220° C., since the cellulose easily decomposes, a large amount of components that will adversely affect the light-sensitive material are generated.

The light-sensitive material package comprises a molded product for a light-sensitive material obtained by any one of the above-mentioned processes and a light-sensitive material that is used with the molded product. In the case where the molded product for a light-sensitive material is a container, a light-sensitive material can be housed therein to give a light-sensitive package.

In order to impart light-shielding performance to a paper resin, the addition of 0.05 to 25 wt % of a light-shielding material thereto can improve the light-shielding function that is required for a molded product used on the periphery of a photographic light-sensitive material without degrading the chemical and physical properties of the paper resin. When the amount is less than 0.05 wt %, light-shielding performance cannot be exhibited, which not only fails to achieve the object of the addition but also increases the cost. When the amount exceeds 25 wt %, the physical strength is degraded and at the same time the appearance becomes poor.

Examples of the light-shielding material that can be added in order to introduce light-shielding performance are as follows:

(1) Inorganic compounds

A. Oxides

Silica, diatomaceous earth, alumina, titanium oxide, iron oxide, zinc oxide, magnesium oxide, antimony oxide, barium ferrite, strontium ferrite, beryllium oxide, pumicite, pumicite balloons, alumina fibers, etc.

B. Carbonates

Calcium carbonate, magnesium carbonate, dolomite, dawsonite, etc.

C. Silicates

Talc, clay, mica, asbestos, glass fiber, glass balloons, glass beads, calcium silicate, montmorillonite, bentonite, etc.

D. Carbon

Carbon black, graphite, carbon fiber, hollow carbon spheres, etc.

E. Others

Iron powder, copper powder, lead powder, tin powder, stainless steel powder, pearl pigment, aluminum powder, molybdenum sulfide, boron fiber, silicon carbide fiber, yellow copper fiber, potassium titanate, lead titanate zirconate, zinc borate, barium metaborate, calcium borate, sodium borate, aluminum paste, etc.

(2) Organic compounds

Wood powder (pine, oak, sawdust, etc.), husk fiber (almond, peanut, chaff, etc.), various types of colored fiber such as cotton and jute, paper pieces, cellophane pieces, nylon fiber, polypropylene fiber, starch, aromatic polyamide fiber, etc.

There are various modes for preparing a light-shielding material, but a concentrated master batch method is preferable in terms of cost, prevention of contamination of the workplace, etc. JP-B-40-26196 (JP-B denotes Japanese examined patent application publication) discloses a method for preparing a polymer-carbon black master batch by dispersing carbon black in a solution of a polymer dissolved in an organic solvent, and JP-B-43-10362 discloses a method for preparing a concentrated master batch by dispersing carbon black in polyethylene. Pellets obtained by mixing a thermoplastic resin with 10 wt % of carbon black in a concentrated manner can be used. A desired light-shielding performance can be obtained by adding carbon black at about 0.5 wt % to the molded product of the present invention.

With regard to the carbon black that is used in the molded product for a light-sensitive material of the present invention, carbon black having a pH of 6.0 to 9.0 and an average particle size of 10 to 120 μm is preferred since fog is not caused in a light-sensitive material, changes in light sensitivity are suppressed, the light-shielding ability is high, and the occurrence of pinholes due to the formation of lumps of carbon black and fisheyes is suppressed even when it is added to the resin composition in the present invention. In particular, furnace carbon black having a volatile component content of 2.0% or less and an oil adsorption of 50 ml/100 g or more is preferred. Channel carbon black is expensive and tends to cause undesirable fog in a light-sensitive material. When its use is required, it should be chosen after examining its influence on the photographic properties.

Examples of preferable commercial products include Carbon black #20(B), #30(B), #33(B), #40(B), #44(B), #45(B), #50, #55, #100, #600 , #2200(B), #2400, #950(B), MA8, MA11 and MA100 (all manufactured by Mitsubishi Chemical Corp.).

As examples of commercial products available outside Japan, Black Pearls 2, 46, 70, 71, 74, 80, 81, 607, etc., Regal 300, 330, 400, 660, 991, SRF-S, etc. Vulcan 3, 6, etc., and Sterling 10, SO, V, S, FT-FF, MT-FF, etc. (all manufactured by Cabot) can be cited. Furthermore, Printex-Alfa and Printex-90 (all manufactured by Degussa-Huls) can be cited. However, they are not limited thereto.

The amount of light-shielding material added is usually 0.05 to 25 wt % relative to the weight of the final molded product, preferably 0.1 to 15 wt %, more preferably 0.5 to 10 wt %, and most preferably 1.0 to 7.0 wt %.

Since the paper resin in the present invention has a low melt flow rate (MFR), a lubricant can be added as long as the effect of the present invention is not degraded.

The names of typical lubricants that can be used in the molded product of the present invention and their manufacturers' names are listed below.

(1) Silicone type lubricants

Various grades of dimethylpolysiloxane and modified compounds thereof (Shin-etsu Silicone Co., Ltd., Toray Silicone, Inc.)

(2) Oleamide type lubricants

Armoslip CP (Lion Akzo), Neutron (Nippon Fine Chemical Co., Ltd.), Neutron E-18 (Nippon Fine Chemical Co., Ltd.), Amido O (Nitto Chemical Industry Co., Ltd.), Alfro E:10 (NOF Corp.), Diamid O-200 (Nippon Kasei Chemical Co., Ltd.), Diamid C-200 (Nippon Kasei Chemical Co., Ltd.), etc.

(3) Erucamide type lubricants

Alfro-F-10 (NOF Corp.), etc.

(4) Stearamide type lubricants

Alfro-S-10 (NOF Corp.), Neutron 2 (Nippon Fine Chemical Co., Ltd.), Diamid 200 (Nippon Kasei Chemical Co., Ltd.), etc.

(5) Bisfatty acid amide type lubricants

Bisamide (Nippon Kasei Chemical Co., Ltd.), Diamid 200 Bis (Nippon Kasei Chemical Co., Ltd.), Armowax BBS (Lion Akzo), etc.

(6) Nonionic surfactant type lubricants

Electrostripper TS-2, Electrostripper-TS-3 (Kao Corp.), etc.

(7) Hydrocarbon type lubricants

Liquid paraffin, natural paraffin, microwax, synthetic paraffin, polyethylene wax, polypropylene wax, chlorinated hydrocarbons, fluorocarbons.

(8) Fatty acid type lubricants

Higher fatty acids (preferably those having 12 carbons or more), oxyfatty acids.

(9) Ester type lubricants

Lower alcohol esters of fatty acids, polyhydric alcohol esters of fatty acids, polyglycol esters of fatty acids, fatty alcohol esters of fatty acids

(10) Alcohol type lubricants

Polyhydric alcohols, polyglycols, polyglycerols.

(11) Metallic soaps

Compounds of a higher fatty acid such as lauric acid, stearic acid, ricinoleic acid, naphthenic acid or oleic acid and a metal such as Li, Mg, Ca, Sr, Ba, Zn, Cd, Al, Sn or Pb.

Preferred embodiments of the molding method of the present invention are listed below.

1) Relationship between the photographic properties and the cylinder temperature when molding

When using paper resin pellets in the present invention, there is a tendency for the cellulose component forming the paper resin pellets to undergo thermal decomposition when molding, thereby causing degradation in the photographic properties, and it is therefore preferable for the molding temperature to be as low as possible. From the results of examining the relationship between the cylinder temperature and the photographic properties, it is desirable for the cylinder temperature to be 180° C. or less, preferably 170° C. or less, and more preferably in the range of 150° C. to 170° C.

2) Relationship between the moldability and the MFR of a resin that is added to the paper resin pellets

Since the paper resin pellets produced from a WP paper have a comparatively long fiber length, the moldability is poor. When the flowability of the resin that is added thereto is poor, short shot molded products are formed. As a result of an investigation by the present inventors, taking the extent of sink marks in the molded product (indentations in the molded product) into consideration, the MFR of the resin that is added is preferably at least 15 g/10 min., more preferably at least 30 g/10 min., and most preferably 45 to 80 g/10 min.

With regard to the molded products for light-sensitive materials of the present invention, there are, for example, a moisture-proof container and its associated member for photographic color paper and, in particular, a moisture-proof container and its component member housing a light-shielding container (cartridge) for photographic film, an instant film pack shown in FIG. 3 (0.9 mm thick black container for instax mini (registered trade name) card size instant film by Fuji Photo Film Co., Ltd.), and a moisture-proof container (including a cover) shown in FIG. 3 for a 135 format film cartridge. In addition, the molded product of the present invention can be used as a 135 format spool, a cartridge for an APS format film, a 110 format film cartridge, a cuboid-shaped cartridge housing a light-sensitive material for printing, a paper tube around which a long length of light-sensitive material is wound, a flange for winding up a long length of light-sensitive material and retaining the opposite sides thereof, a cushioning material that is placed in a container for a light-sensitive material, supporting board for a light-sensitive material laminate (a package or a part thereof that is in contact with a light-sensitive material laminate), a film container equipped with a lens (registered trademark ‘Utsurundesu’ of Fuji Photo Film, Co., Ltd.), etc.

The molded product of the present invention does not degrade the photographic properties and has excellent mechanical properties. Furthermore, the proportion of cellulose fibers in the molded product exceeds 50 wt %, and the product can therefore be disposed of with a lower burden on the environment.

Refuse from uncoated printing paper generated in the process for the production of printing paper, etc. can be effectively recycled to give a light-sensitive material package or a functional component.

Molding at a cylinder temperature of as low as about 170° C. using an antioxidant and an aldehyde-neutralizing agent can give a container having a good storage performance so that it does not degrade the photographic properties of a light-sensitive material that is housed therein.

### EXAMPLES

Specific examples of the present invention are explained below together with comparative examples, but they are not intended to limit the present invention.

### Example 1

In accordance with the above-mentioned detailed production process example, an instax mini (registered trademark of Fuji Photo Film Co., Ltd.) case was produced. Paper refuse of a waterproof paper for printing paper formed by laminating 25 wt % of PE on both surfaces of 75 wt % of a base paper for printing paper were roughly broken, then fiberized by means of a refiner, temporarily made into pellets, and then broken by means of a turbo mill. A concentrated carbon black master batch and HDPE were added thereto to give paper resin pellets. Concentrated antioxidant pellets and concentrated neutralizing agent pellets were added to the paper resin pellets, and an instax mini case was injection molded with a molding thickness of 0.8 mm.

As the antioxidant, Adeka Stab AO-30 (1,1,3-tris(2-methyl-4-hydroxy-5-t-butylphenyl)butane) from Asahi Denka Kogyo K.K. was used. As the neutralizing agent, 5,5-dimethylhydantoin manufactured by Mitsui Chemicals Inc. was used.

The ratio by weight of the paper-derived cellulose fibers to the total of the thermoplastic resins, the amounts of the antioxidant and the neutralizing agent added, and the molding temperature were changed as shown in Table 1 to give Samples A to J. Other production conditions are described below.

TABLE 1

| | Example | | | | |
|---|---|---|---|---|---|
| Sample | B | C | D | E | F |
| Ratio by weight | 51:49 | 51:49 | 60:40 | 70:30 | 75:25 |
| Cellulose fiber:resin | | | | | |
| Weight-average fiber | 0.3 | 0.3 | 0.3 | 0.3 | 0.3 |
| length (mm) | | | | | |
| Antioxidant (wt %) | 0.3 | 0.6 | 0.3 | 0.3 | 0.3 |
| Aldehyde-neutralizing | 0.3 | 0.6 | 0.3 | 0.3 | 0.3 |
| agent (wt %) | | | | | |
| Cylinder temperature (° C.) | 170 | 170 | 170 | 170 | 170 |
| | Example | | | Comparative | |
| Sample | H | I | J | A | G |
| Ratio by weight | 51:49 | 51:49 | 51:49 | 51:49 | 80:20 |
| Cellulose fiber:resin | | | | | |
| Weight-average fiber | 0.3 | 0.3 | 0.3 | 0.3 | 0.3 |
| length (mm) | | | | | |
| Antioxidant (wt %) | 0.3 | 0.3 | 0.3 | 0 | 0.3 |
| Aldehyde-neutralizing | 0.3 | 0.3 | 0.3 | 0 | 0.3 |
| agent (wt %) | | | | | |
| Cylinder temperature (° C.) | 180 | 190 | 200 | 170 | 170 |

An overall evaluation of the above-mentioned samples was carried out based on the feasibility of molding (injection pressure), the charring when molding, the photographic properties, the appearance of the molded product, etc. The results are given in Table 2.

The photographic properties were evaluated by measuring the change (ΔDₘₐₓ) in fog density. ΔDₘₐₓ is the value obtained from the equation ΔDₘₐₓ=M_{b}−Mₜ. Mₜ is the highest blue density when an instax mini light-sensitive material manufactured by Fuji Photo Film Co., Ltd. was loaded into each of the Cases A to J, hermetically sealed, stored at 50° C. and 60% RH for 3 days, and then developed by a standard method. M_{b} is the value obtained when the above-mentioned light-sensitive material was stored in a case made of a thermoplastic resin and hermetically sealed. The same applies to Examples 2 and 3.

TABLE 2

| Sample | A | B | C | D | E |
|---|---|---|---|---|---|
| Injection pressure (MPa) *1 | 6.5 | 6.5 | 6.5 | 6.8 | 7.5 |
| Charring when molding *2 | C | A | A | A | A |
| Photographic properties | 0.18 | 0.11 | 0.10 | 0.11 | 0.12 |
| ΔDₘₐₓ | | | | | |
| Appearance of molded | A | A | B | A | A |
| product *3 | | | | | |
| Effect of antioxidant *4 | C | A | A | A | A |
| Effect of aldehyde- | C | A | A | A | A |
| neutralizing agent *5 | | | | | |
| Overall evaluation *6 | C | A | A/B | A | A |
| Sample | F | G | H | I | J |
| Injection pressure (MPa) *1 | 8.4 | 9.1 | 6.3 | 6.0 | 5.7 |
| Charring when molding *2 | A | — | A | B | B |
| Photographic properties | 0.13 | — | 0.13 | 0.20 | 0.22 |
| ΔDₘₐₓ | | | | | |
| Appearance of molded | A | — | A | B | B |
| product *3 | | | | | |
| Effect of antioxidant *4 | A | — | A | B | B |
| Effect of aldehyde- | A | — | A | B | B |
| neutralizing agent *5 | | | | | |
| Overall evaluation*6 | A | C | A | B | B |

*1 When the injection pressure exceeded 9.0 MPa, molding could not be carried out.
*2, 3 A: No problem in practice, B: acceptable in practice, C: problem in practice.
*4, 5 A: Effective, B: slightly effective, C: no effect.
*6 A: No problem in practice and can be used. B: Acceptable in practice. C: Problem in practice and cannot be used.

The following points were found from the above-mentioned results.

(1) When the component ratio by weight of the paper-derived cellulose fibers to the total of the thermoplastic resins exceeds 75:25, the injection pressure becomes too high for molding.

(2) Adding the antioxidant and the aldehyde-neutralizing agent at 0.01 to 0.5 wt % can suppress the thermal decomposition of cellulose fibers.

(3) When the amounts of the antioxidant and the aldehyde-neutralizing agent added exceed 0.5 wt %, the appearance becomes poor.

### Example 2

1) As a starting material a waterproof paper for printing paper was used that had been formed by laminating a polyolefin resin on a base paper produced for printing paper using hardwood bleached kraft pulp (LBKP) having a weight-average fiber length of 0.7 mm measured using an FS-100 measuring machine manufactured by Kajaani Co.

This waterproof paper for printing paper was formed by laminating 25 parts by weight of a PE resin on 75 parts by weight of the base paper.

2) The waterproof paper for printing paper was roughly broken by means of a shearing machine.

3) The waterproof paper roughly broken in this way was broken using a pin mill into cellulose fibers in a torn flock state.

4) The highly bulky flock-state cellulose fibers were compression-kneaded using a pellet mill to give pellets.

5) 100 parts by weight of the pellets so obtained were mixed with 52 parts by weight of ldemitsu Petroleum PJ68083HP PP resin, 0.2 wt % of Adeka Stab AO-30 (1,1,3-tris(2-methyl-4-hydroxy-5-t-butylphenyl)butane) from Asahi Denka Kogyo K.K. as the antioxidant, 0.2 wt % of 5,5-dimethylhydantoin manufactured by Mitsui Chemicals, Inc. as the neutralizing agent, and 0.5 wt % of carbon black #950 from Mitsubishi Chemical Corp. to give a sample.

6) The sample was broken using the above-mentioned turbo-mill while changing the number of treatments as shown in Table 3.

7) The sample so broken was kneaded and granulated in an extruder at a cylinder temperature of 170° C. to give paper resin pellets.

8) An instant film pack having a thickness of 1 mm was molded using each of the paper resin pellet samples to give a pack sample. The molding conditions, etc. were as follows: a Sumitomo Heavy Industries, Ltd. SG180 molding machine was used, the resin temperature was 170° C., and the mold temperature was 70° C.

9) The maximum injection pressure when molding, the weight-average fiber length of the cellulose in the molded product, the drop strength, and the photographic properties when combined with an instant film were evaluated. The evaluation results are given in Table 3.

TABLE 3

| | Sample No. | | | | |
|---|---|---|---|---|---|
| | K | L | M | N | O |
| Number of turbo-mill | 0 | 1 | 2 | 3 | 4 |
| treatments (times) | | | | | |
| Fiber length (mm) | 0.6 | 0.5 | 0.4 | 0.3 | 0.2 |
| Drop strength *1 | A | A | A | A | B |
| Photographic properties | 0.10 | 0.11 | 0.11 | 0.11 | 0.18 |
| ΔDₘₐₓ | | | | | |
| Maximum injection | 9.2 | 7.0 | 6.5 | 6.0 | 5.8 |
| pressure (MPa) | | | | | |
| Overall evaluation *2 | B | A | A | A | B |

*1 At level IV of JIS Z0200 A: No problem, B: small crack in a corner of the molded product
*2 A: No problem in practice and can be used. B: Acceptable in practice. C: Problem in practice and cannot be used.

The following points were found from the above-mentioned results.

(1) The weight-average fiber length depends on the number of turbo-mill treatments.

(2) When the weight-average fiber length exceeds 0.5 mm, the compartibility with a resin drops, and the flowability of the paper resin when molding degrades, thereby causing short shots.

(3) When the weight-average fiber length is less than 0.3 mm, the cellulose easily undergoes thermal decomposition to form aldehydes, thereby degarding the photographic properties.

### Example 3

Paper resin pellets were obtained as in Example 2 except that the amoount of neutralizing agent added was changed as shown in Table 4 and after one treatment with a turbo-mill the treatment with an extruder was carried out.

An instant film pack was molded using the above-mentioned paper resin pellets under the same molding conditions as in Example 2. The odor due to trace amounts of aldehyde generated by thermal decomposition when molding, and the photogaphic properties after loading a film were evaluated.

The evaluation of the odor was carried out by 10 randomly chosen panelists using the evaluation criteria below, and is given as an average value.

The molded product samples were named F to L.

| Intensity of odor | Strength of sensation of odor |
|---|---|
| 5 | No odor |
| 4 | Very slight sensation of odor (detection threshold) |
| 3 | Easily sensed odor |
| 2 | Obvious sensation of odor |
| 1 | Strong odor |
| 0 | Unbearably strong odor |

When the odor level is 4 or above, there is no problem in practice.

TABLE 4

| Sample No. | P | Q | R | S | T | U | V |
|---|---|---|---|---|---|---|---|
| Amount of | 0.00 | 0.01 | 0.03 | 0.10 | 0.20 | 0.30 | 0.40 |
| neutralizing agent | | | | | | | |
| added (wt %) | | | | | | | |
| Photographic | 0.10 | 0.09 | 0.02 | 0.01 | 0.009 | 0.009 | 0.009 |
| properties ΔDₘₐₓ | | | | | | | |
| Odor | 1 | 4 | 4 | 5 | 5 | 5 | 5 |
| Overall evaluation *1 | C | B | B | A | A | A | B |

*1 AB: No problem in practice and can be used. C: Problem in practice and cannot be used.

### Example 4

The cases for housing photographic film shown in FIG. 3 were molded by an injection molding method in the same manner as in Example 1 to give the samples shown in Table 5. The thickness of the cases for housing photographic film was 0.8 mm. The molding was carried out using a Sumitomo Heavy Industries, Ltd. SG180 molding machine at a cylinder temperature of 170° C. For both Sample Nos. 1 and 2, molding of the case employed a base paper having a weight-average fiber length of the cellulose fibers after breaking of 0.3 mm. The ratio by weight of the cellulose fibers to the total of the thermoplastic resins in the molded product was 51:49, the antioxidant content was 0.3 wt %, and the aldehyde-neutralizing agent content was 0.3 wt %.

The photographic properties were evaluated by measuring the change (ΔDₘᵢₙ) in fog density. ΔDₘᵢₙ is the value obtained from the equation ΔDₘᵢₙ=Mₜ−M_{b}. Mₜ is the lowest blue density when a negative color film SUPERIA 400 manufactured by Fuji Photo Film Co., Ltd. was housed in case 1 or case 2, hermetically sealed, stored at 50° C. and 60% RH for 3 days, and then developed by a standard method. M_{b} is the value obtained when the above-mentioned film was housed in a case made of a thermoplastic resin and hermetically sealed.

TABLE 5

| | MFR | Injection | Photographic | |
|---|---|---|---|---|
| No. | (g/10 min.) | pressure (MPa) | properties ΔDmin | Moldability *3 |
| 1 | 20 *1 | 7.6 | 0.01 | A |
| 2 | 40 *2 | 6.0 | 0.01 | A |

*1 Idemitsu Petroleum 100J
*2 Japan Polyolefin KMA90K
*3 A: Good.

### Example 5

In accordance with the above-mentioned detailed production process example, a reinforcing rib in the cushioning material shown in FIG. 2 was produced. Paper refuse of a waterproof paper for printing paper formed by laminating 25 wt % of PE on both surfaces of 75 wt % of a base paper for printing paper were roughly broken, then fiberized by means of a refiner, temporarily made into pellets, and then broken by means of a turbo mill. A concentrated carbon black master batch and HDPE were added thereto to give paper resin pellets. Concentrated antioxidant pellets and concentrated neutralizing agent pellets were added to the paper resin pellets, and reinforcing ribs were injection molded to give the molding thicknesses shown in Table 6. A Sumitomo Heavy Industries, Ltd. SG75 molding machine was used.

As the antioxidant, Adeka Stab AO-30 (1,1,3-tris(2-methyl-4-hydroxy-5-t-butylphenyl)butane) from Asahi Denka Kogyo K.K. was used. As the neutralizing agent, 5,5-dimethylhydantoin manufactured by Mitsui Chemicals, Inc. was used.

The ratio by weight of the paper-derived cellulose fibers to the total of the thermoplastic resins, the amounts of the antioxidant and the neutralizing agent added, and the molding temperature were changed as shown in Table 6.

TABLE 6

| | Embodiment | | | | |
|---|---|---|---|---|---|
| Sample | 3 | 4 | 5 | 6 | 7 |
| Ratio by weight | 51:49 | 51:49 | 51:49 | 51:49 | 51:49 |
| Cellulose fiber:resin | | | | | |
| Weight-average fiber | 0.3 | 0.3 | 0.3 | 0.3 | 0.3 |
| length (mm) | | | | | |
| Antioxidant (wt %) | 0 | 0.1 | 0 | 0.1 | 0.1 |
| Aldehyde-neutralizing | 0 | 0.1 | 0 | 0.1 | 0.1 |
| agent (wt %) | | | | | |
| Cylinder temperature (° C.) | 170 | 170 | 170 | 170 | 170 |
| Thickness of | 1.0 | 1.0 | 1.5 | 1.5 | 5 |
| reinforcing rib (mm) | | | | | |

An overall evaluation of the above-mentioned samples was carried out based on the feasibility of molding, the charring when molding, the photographic properties, the appearance of the molded product, etc. The results are given in Table 7.

The photographic properties were evaluated by measuring the change (ΔDₘᵢₙ) in fog density. ΔDₘᵢₙ is the value obtained from the equation ΔDₘᵢₙ=Mₜ−M_{b}. Mₜ is the lowest blue density when a light-sensitive printing material S-FA100 manufactured by Fuji Photo Film Co., Ltd. was housed in cases using each of the cushioning materials 3 to 7, hermetically sealed, stored at 50° C. and 60% RH for 3 days, and then developed by a standard method. M_{b} is the value obtained when the above-mentioned light-sensitive printing material was housed in a case made of a thermoplastic resin and hermetically sealed.

TABLE 7

| Sample | 3 | 4 | 5 | 6 | 7 |
|---|---|---|---|---|---|
| Moldability *1 | B | B | B | B | B |
| Charring when molding *2 | B | B | B | B | B |
| Photographic properties | 0.05 | 0.01 | 0.03 | 0.00 | 0.01 |
| ΔDₘᵢₙ | | | | | |
| Appearance of molded | B | B | C | B | B |
| product *3 | | | | | |
| Effect of antioxidant *4 | C | B | C | B | B |
| Effect of aldehyde- | C | B | C | B | B |
| neutralizing agent *5 | | | | | |
| Drop test*6 | B | B | B | B | B |
| Overall evaluation *7 | C | B | C | A | A |

*1 B: Good molding, C: cannot be molded.
*2, 3 B: No problem in practice, C: problem in practice.
*4, 5 B: Effective, C: no effect.
*6 Drop test was carried out in accordance with JIS Z0202 Level II. B: Good.
*7 A, B: No problem in practice and can be used. C: Problem in practice and cannot be used.

Although embodiments of the present invention have been explained above, the present invention is not limited by the above-mentioned embodiments, and the present invention can be modified in a variety of ways without departing from the spirit and scope of the appended claims.

### Example 6

Instax mini cases B′ to J′ were produced the same way as Sample B to J in Example 1, except that 2,6-di-tert-butyl-4-n-butylphenol was used the same mole instead of 1,1,3-tris(2-methyl-4-hydroxy-5-t-butylphenyl)butane and that 5,5-diphenylhydantoin was used the same mole instead of 5,5-dimethylhydantoin. The instax mini cases showed good results similar to the results summarized in Table 2.

What is claimed is:

1. A molded product for a light-sensitive material having a component ratio by weight of paper-derived cellulose fibers to the total of thermoplastic resins in the range of 51:49 to 75:25, comprising:
at least one antioxidant; and
at least one aldehyde-neutralizing agent.

2. The molded product for a light-sensitive material according to claim 1, wherein the antioxidant comprises a hindered phenol antioxidant at 0.01 to 0.5 wt % of the molded product.

3. The molded product for a light-sensitive material according to claim 1, wherein the aldehyde-neutralizing agent comprises a hydantoin compound at 0.05 to 0.5 wt % of the molded product.

4. The molded product for a light-sensitive material according to claim 1, wherein the component ratio by weight of the cellulose fibers to the total of the thermoplastic resins is in the range of 51:49 to 75:25, the cellulose fibers having a weight-average fiber length in the range of 0.30 mm to 0.50 mm after breaking a base paper made from kraft pulp.

5. The molded product for a light-sensitive material according to claim 1, wherein the molded product has a thickness of 0.5 mm to 10 mm.

6. The molded product for a light-sensitive material according to claim 1, wherein the molded product comprises a base paper and a polyolefin resin and is made by a process comprising steps of:
breaking a waterproof paper for printing paper, the waterproof paper being obtained by laminating a base paper produced for printing paper with a polyolefin resin, to give a mixture of cellulose fibers and the polyolefin resin;
adding an additional thermoplastic resin to the mixture if necessary; and
molding so that the ratio by weight of the base-paper-derived cellulose fibers to the total of the polyolefin resin and the additional thermoplastic resin is in the range of 51:49 to 75:25.

7. A light-sensitive material package comprising:
a molded product for a light-sensitive material; and
a light-sensitive material that is used with the molded product, the molded product for a light-sensitive material having a component ratio by weight of paper-derived cellulose fibers to the total of thermoplastic resins in the range of 51:49 to 75:25 and comprising at least one antioxidant and at least one aldehyde-neutralizing agent.

8. The light-sensitive material package according to claim 7, wherein the antioxidant comprises a hindered phenol antioxidant at 0.01 to 0.5 wt % of the molded product.

9. The light-sensitive material package according to claim 7, wherein the aldehyde-neutralizing agent comprises a hydantoin compound at 0.05 to 0.5 wt % of the molded product.

10. The light-sensitive material package according to claim 7, wherein the component ratio by weight of the cellulose fibers to the total of the thermoplastic resins in the molded product is in the range of 51:49 to 75:25, the cellulose fibers having a weight-average fiber length in the range of 0.30 mm to 0.50 mm after breaking a base paper made from kraft pulp.

11. The light-sensitive material package according to claim 7, wherein the molded product has a thickness of 0.5 mm to 10 mm.

12. The light-sensitive material package according to claim 7, wherein the molded product comprises a base paper and a polyolefin resin and is made by a process comprising steps of:
breaking a waterproof paper for printing paper, the waterproof paper being obtained by laminating a base paper produced for printing paper with a polyolefin resin, to give a mixture of cellulose fibers and the polyolefin resin;
adding an additional thermoplastic resin to the mixture if necessary; and
molding so that the ratio by weight of the base-paper-derived cellulose fibers to the total of the polyolefin resin and the additional thermoplastic resin is in the range of 51:49 to 75:25.

13. A process for producing a molded product for a light-sensitive material comprising, in the following order, steps of:
mixing a thermoplastic resin having a melt flow rate of at least 15 g/10 min. with pellets formed by breaking, compressing and granulating a base paper produced for printing paper, so that the component proportions are 51 to 75 parts by weight of paper-derived cellulose fibers and 49 to 25 parts by weight of the total of the thermoplastic resins; and
molding the mixture with a molding machine at a cylinder temperature of 180° C. or less.

14. The process for producing a molded product for a light-sensitive material according to claim 13, wherein the melt flow rate is at least 30 g/10 min.

15. The process for producing a molded product for a light-sensitive material according to claim 13, wherein concentrated antioxidant pellets and concentrated aldehyde-neutralizing agent pellets are supplied to the molding machine together with the paper resin pellets.
